(19) United States
(12) Patent Application Publication
(10) Pub. No.: US 2024/0380068 A1
(43) Pub. Date: Nov. 14, 2024

(54) Vent Sealing Cap for Secondary Battery and Secondary Battery Including the Same

(71) Applicant: LG Energy Solution, Ltd., Seoul (KR)

(72) Inventors: Sang Seung Oh, Daejeon (KR); Sung Chul Lim, Daejeon (KR)

(73) Assignee: LG Energy Solution, Ltd., Seoul (KR)

(21) Appl. No.: 18/563,165

(22) PCT Filed: Jun. 16, 2022
(86) PCT No.: PCT/KR2022/008536

§ 371 Date: Nov. 21, 2023

(30) Foreign Application Priority Data
Jun. 18, 2021 (KR) 10-2021-0079632
Jun. 15, 2022 (KR) 10-2022-0072951

(51) Int. Cl. H01M 50/383; H01M 10/48; H01M 50/105; H01M 50/342

(52) U.S. Cl. CPC H01M 50/383; H01M 10/48; H01M 50/105; H01M 50/3425

(57) ABSTRACT

The present invention relates to a vent sealing cap for a secondary battery and a secondary battery including the same.

The vent sealing cap for a secondary battery may includes a body having a hollow therein, an intake port provided on the body, an exhaust port provided above a position, at which the intake port is disposed; on the body, and an opening/closing member provided in the hollow within the body to open or close connection between the intake port and the exhaust port while moving by a change in pressure of the intake port.

### CROSS-REFERENCE TO RELATED APPLICATION

The present application is a national phase entry under 35 U.S.C. § 371 of International Application No. PCT/KR2022/008536 filed on Jun. 16, 2022, which claims the benefit of the priority of Korean Patent Application Nos. 10-2021-0079632, filed on Jun. 18, 2021, and 10-2022-0072951, filed on Jun. 15, 2022, which are hereby incorporated by reference in their entirety.

### TECHNICAL FIELD

The present invention relates to a vent sealing cap for a secondary battery and a secondary battery including the same, and more particularly, to a vent sealing cap for a secondary battery, which is capable of preventing oxygen from entering the secondary battery after a gas generated in the secondary battery is discharged to the outside to prevent the secondary battery from igniting and thereby improving safety, and a secondary battery including the same.

### BACKGROUND ART

In general, secondary batteries mean batteries that are chargeable and dischargeable unlike primary batteries that are not chargeable, and the secondary batteries are widely used for power of electronic devices such as mobile phones, notebook computers, camcorders, and the like, electric vehicles, and the like.

In general, secondary batteries include nickel-cadmium batteries, nickel-hydrogen batteries, lithium ion batteries, and lithium ion polymer batteries. Such a secondary battery is being applied to be used in small-sized products such as digital cameras, notebooks, mobile phones, PDAs, E-bikes, and the like as well as large-sized products requiring high power such as electric vehicles and hybrid vehicles, power storage devices for storing surplus power or renewable energy, and backup power storage devices.

Such a secondary battery is classified as a pouch-type secondary battery or a can type secondary battery according to a material of a battery case accommodating an electrode assembly. In the pouch-type secondary battery, the electrode assembly is accommodated in a pouch made of a flexible polymer material having a variable shape. In addition, in the can type secondary battery, an electrode assembly is accommodated in a case made of a metal or plastic material having a predetermined shape.

As described above, the electrode assembly is accommodated in the battery case, and an electrolyte is injected and then sealed to operate as a battery. In the secondary battery, a gas is generated during the charging and discharging processes. Particularly, when the battery is overcharged, or short circuit occurs in the battery, the gas is excessively generated in the battery to increase in pressure within the battery case, thereby deteriorating performance of the battery.

Accordingly, a process or device for performing ventilation for discharging the internal gas to the outside is essentially required for the secondary battery. However, during the venting process of the secondary battery, external air is sometimes introduced into the inside of the battery. In this case, not only the performance of the battery is deteriorated, but also oxygen reacts inside the battery, leading to ignition or explosion of the battery, thereby seriously threatening safety of a user.

Accordingly, there is a need to develop a means for regulating the internal pressure of the battery by properly preventing the external air from being introduced while discharging the gas generated inside the battery to the outside.

### DISCLOSURE OF THE INVENTION

### Technical Problem

The present invention has been devised to solve the above problems, and an object of the present invention is provide a vent sealing cap for a secondary battery, which is capable of preventing oxygen from being introduced reversely after a gas generated in the secondary battery is discharged to the outside to prevent the secondary battery from being ignited and improve safety, and a secondary battery including the same.

### Technical Solution

A vent sealing cap for a secondary battery according to the present invention includes a body having a hollow therein, an intake port provided on the body, an exhaust port provided above a position, at which the intake port is disposed, on the body, and an opening/closing member provided in the hollow within the body to open or close connection between the intake port and the exhaust port while moving by a change in pressure of the intake port.

The intake port may be provided on a side surface of the body.

The exhaust port may be provided on the side surface of the body, wherein the exhaust port may be provided on an axis different from an axis, on which the intake port is provided, with respect to a transverse cross-section of the body.

The opening/closing member may open the connection between the intake port and the exhaust port when the pressure of the intake port is greater than a preset value, and the opening/closing member may close the connection between the intake port and the exhaust port when the pressure of the intake port is less than the preset value.

The opening/closing member may include an elevation assistance groove that is opened in a direction, in which the gas is introduced through the intake port, and has a shape recessed toward a central portion of the opening/closing member.

The elevation assistance groove may be provided in a hairpin structure including an inlet, through which the gas is introduced, and a head having a spherical shape having a diameter greater than a width of the inlet.

The body may have a transverse cross-section having a circular shape.

A spiral guide groove may be formed in an inner circumferential surface of the body.

A spiral guide protrusion may be formed on an outer circumferential surface of the opening/closing member, wherein the guide protrusion may be inserted into the guide groove of the body so as to be elevated.

The intake port may include a member that is contracted by absorbing heat.

The exhaust port may include an alarm generation device configured to generate a signal by sensing a flow of the gas.

The body may include: a movable part having a cross-sectional area of the hollow, which is the same as a transverse cross-sectional area of the opening/closing member, so that the opening/closing member is movable in a state in which the hollow is sealed; and a stopping part provided below the movable part and having a cross-sectional area of the hollow, which is less than the transverse cross-sectional area of the opening/closing member, so that the movement of the opening/closing member is stopped.

The exhaust port may be formed on a side surface of the movable part, and the intake port may be formed on a side surface of the stopping part.

The intake port may be formed on a side surface of the movable part, and the intake port may be formed on a bottom surface of the stopping part.

A secondary battery according to the present invention includes an electrode assembly in which a positive electrode, a separator, a negative electrode, and a separator are stacked, a battery case in which the electrode assembly is accommodated, and a vent sealing cap provided in the battery case, wherein the vent sealing cap includes a body having a hollow therein, an intake port provided on the body, an exhaust port provided above a position, at which the intake port is disposed, on the body, and an opening/closing member provided in the hollow within the body to open or close connection between the intake port and the exhaust port while moving by a pressure difference of the intake port.

The opening/closing member may include an elevation assistance groove that is opened in a direction, in which the gas is introduced through the intake port, and has a shape recessed toward a central portion of the opening/closing member.

The elevation assistance groove may be provided in a hairpin structure including an inlet, through which the gas is introduced, and a head having a spherical shape having a diameter greater than a width of the inlet.

### Advantageous Effects

In the vent sealing cap for the secondary battery and the secondary battery including the same according to the present invention, the vent sealing cap may include the body having the hollow therein, the intake port provided on the body, the exhaust port provided above the position, in which the intake port is provided, in the body, and the opening/closing member that is provided in the hollow within the body to open or close the connection between the intake port and the exhaust port while moving by the change in pressure of the intake port. Therefore, the vent sealing cap may prevent the oxygen from being introduced reversely after the gas generated in the secondary battery is discharged to the outside to prevent the secondary battery from being ignited and improve the safety.

### BRIEF DESCRIPTION OF THE DRAWINGS

FIG. 1 is a side cross-sectional view of a vent sealing cap for a secondary battery according to an embodiment of the present invention.

FIGS. 2A-2C are schematic views of a ventilation process of the vent sealing cap of FIG. 1.

FIG. 3 is a cross-sectional view taken along line A-A′ of the vent sealing cap of FIG. 1.

FIG. 4 is a side cross-sectional view of a vent sealing cap for a secondary battery according to another embodiment of the present invention.

FIGS. 5A-5C are schematic views of a ventilation process of the vent sealing cap of FIG. 4.

FIG. 6 is a side cross-sectional view illustrating a state in which an intake port is formed on a bottom surface of a stopping part in the vent sealing cap for the secondary battery according to Embodiment 2 of the present invention.

FIG. 7 is a perspective view of a secondary battery according to an embodiment of the present invention.

### MODE FOR CARRYING OUT THE INVENTION

Hereinafter, preferred embodiments of the present invention will be described in detail with reference to the accompanying drawings so that those of ordinary skill in the art can easily carry out the present invention. However, the present invention may be implemented in several different forms and is not limited or restricted by the following examples.

In order to clearly explain the present invention, detailed descriptions of portions that are irrelevant to the description or related known technologies that may unnecessarily obscure the gist of the present invention have been omitted, and in the present specification, reference symbols are added to components in each drawing. In this case, the same or similar reference numerals are assigned to the same or similar elements throughout the specification.

Also, terms or words used in this specification and claims should not be restrictively interpreted as ordinary meanings or dictionary-based meanings, but should be interpreted as meanings and concepts conforming to the scope of the present invention on the basis of the principle that an inventor can properly define the concept of a term to describe and explain his or her invention in the best ways.

### Embodiment 1

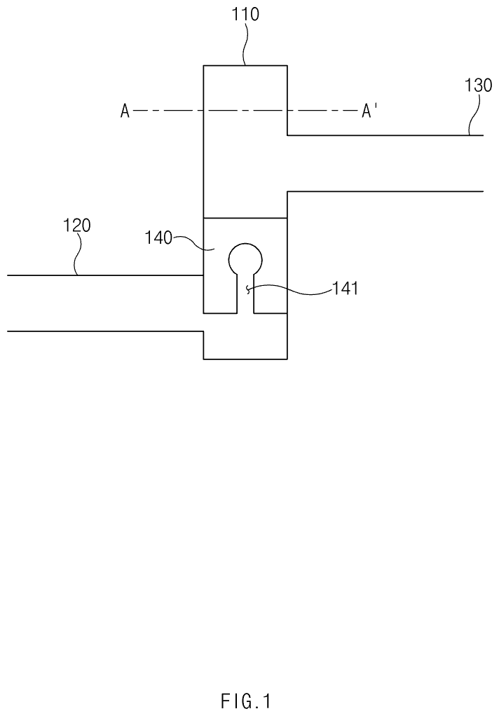

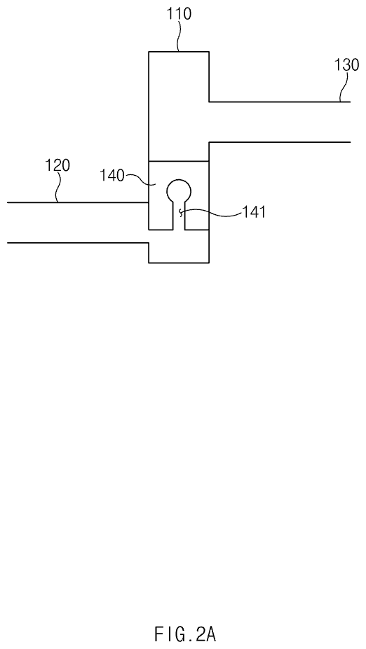

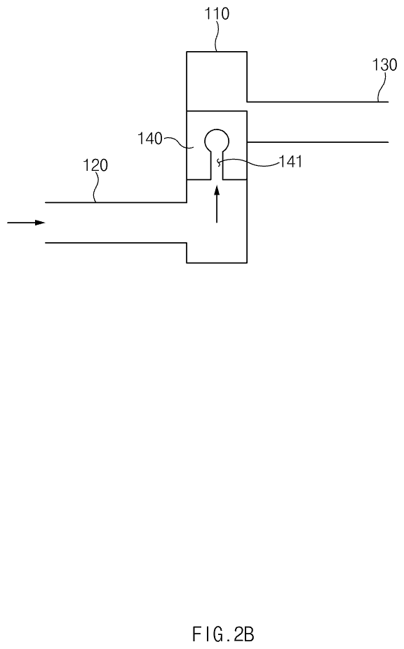

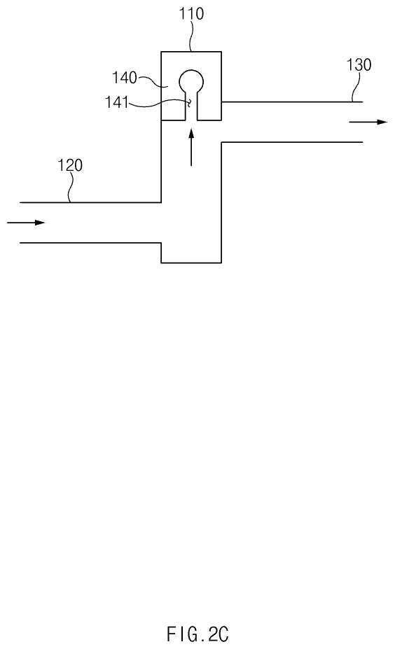

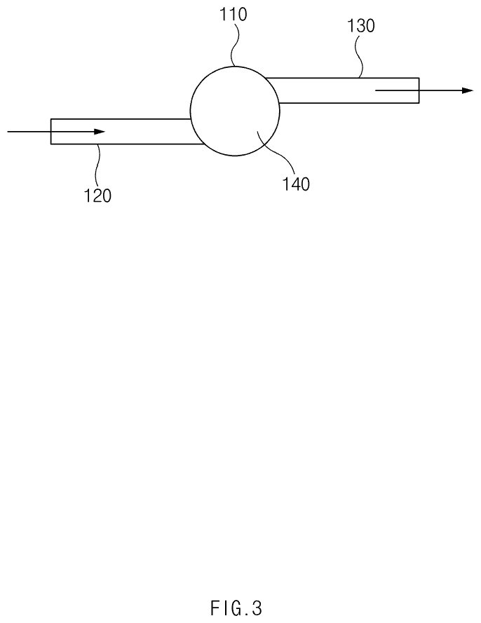

FIG. 1 is a side cross-sectional view of a vent sealing cap for a secondary battery according to Embodiment 1 of the present invention. FIGS. 2A-2C are views illustrating a process of performing ventilation in the vent sealing cap for the secondary battery according to Embodiment 1 of the present invention. FIG. 3 is a cross-sectional view taken along line A-A′ in the vent sealing cap for the secondary battery of FIG. 1.

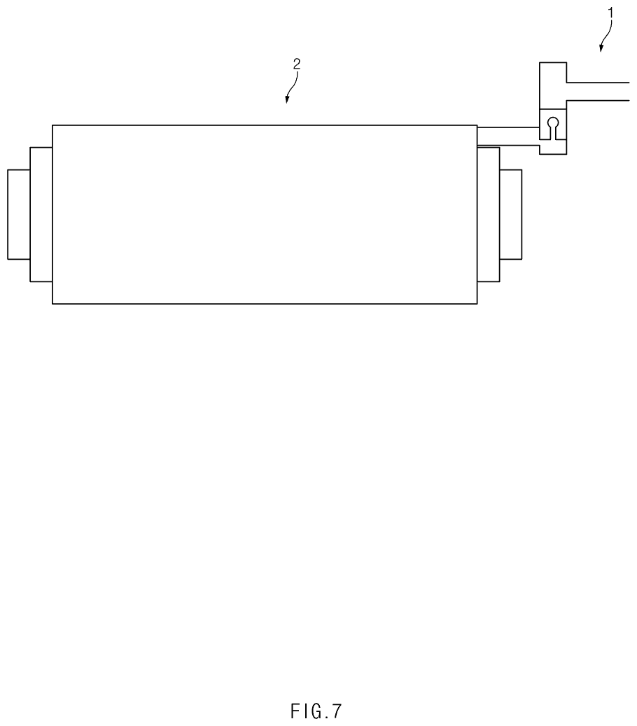

Referring to FIG. 1, a vent sealing cap 1 for a secondary battery according to Embodiment 1 of the present invention includes a body 110, an intake port 120, an exhaust port 130, and an opening/closing member 140. The vent sealing cap 1 for the secondary battery according to the present invention may be provided in a battery case of the secondary battery (see FIG. 7), and in this case, the vent sealing cap 1 may serve to discharge a gas within the battery case to the outside.

The body 110 of the vent sealing cap 1 for the secondary battery has a hollow formed therein, and the intake port 120 and the exhaust port 130 are provided on the body 110. Here, the exhaust port 130 is disposed above a position, at which the intake port 120 is provided, on the body 110. The intake port 120 is connected to the inside of the battery case so that air is introduced into the body 110 from the battery case of the secondary battery, and the air introduced into the intake port 120 is discharged through the exhaust port 130 via the body 110.

Referring to FIGS. 2A-2C, the opening/closing member 140 of the vent sealing cap 1 for the secondary battery according to Embodiment 1 of the present invention is provided in the hollow inside of the body 110 to open or close connection between the intake port 120 and the exhaust port 130 while moving inside the hollow by a change in pressure of the intake port 120. Here, the opening of the connection between the intake port 120 and the exhaust port 130 means that the opening/closing member 140 moves above the body 110 to open a flow of the air between the intake port 120 and the exhaust port 130 (see FIG. 2C), and the closing of the connection between the intake port 120 and the exhaust port 130 means that the opening/closing member 140 is provided between the intake port 120 and the exhaust port 130 in the hollow within the body 110 to block the flow of the air between the intake port 120 and the exhaust port 130 (see FIGS. 2A and 2B).

As described above, in the vent sealing cap 1 for the secondary battery according to Embodiment 1 of the present invention, when the gas is generated in the secondary battery to increase in internal pressure, the generated internal gas may be discharged to the outside, and when the pressure decreases due to the discharge of the gas, the vent sealing cap 1 may be closed to prevent the air from being reversely introduced, thereby preventing ignition or explosion from occurring due to reaction of oxygen inside the battery and improving the safety of the battery.

Hereinafter, each of configurations of the body 110, the intake port 120, the exhaust port 130, and the opening/closing member 140 will be described in detail with reference to FIGS. 1 and 2.

As illustrated in FIG. 1, the body 110 may be formed in a pillar shape having a height and have a hollow so that a fluid therein is movable. In addition, the opening/closing member 140 to be described later may be inserted into the hollow within the body.

A transverse cross-section of the body 110 may be formed in a polygonal shape or may be formed in a circular shape. As described above, when the transverse cross section of the body 110 is formed in the circular shape, a spiral guide groove may be formed in an inner circumferential surface of the body 110, and a guide protrusion formed on the opening/closing member 140 to be described later may be inserted into the guide groove so that the opening/closing member 140 is elevated while rotating. As described above, the opening/closing member 140 may be elevated by a pressure of the intake port 120 while improving sealing force of the opening/closing member 140 by the spiral guide groove formed in the inner circumferential surface of the body 110 and the spiral guide protrusion formed on the outer circumferential surface of the opening/closing member 140, and as necessary, the opening/closing member 140 may be utilized as a means to adjust the pressure for generating the ventilation.

The intake port 120 may be provided on the body 110, and in particular, may be provided on a side surface of the body 110. Since the vent sealing cap 1 for the secondary battery according to the present invention has a structure that uses a self-weight of the opening/closing member 140 provided inside the body 110, the vent sealing cap 1 has to be provided in an erected state to be affected by the gravity. However, when the intake port 120 is provided on a bottom surface of the body 110, in the body 110 of the vent sealing cap 1, a case in which a placed shape of the secondary battery and the vent sealing cap 1 are not provided in the erected state according to a position at which the battery case is provided.

Therefore, in order to prevent this, the intake port 120 may be provided on a side surface of the body 110, and as a result, regardless of the placed shape of the secondary battery or the position at which the vent sealing cap 1 is provided in the battery case, the body 110 of the vent sealing cap 1 may be provided in the erected state to be affected by the gravity, and thus, the opening and closing functions by the opening/closing member 140 of the present invention may be normally performed.

The intake port 120 may be provided in the form of a hose connected to the body 110 and may be configured to be introduced from the outside to the inside of the body 110. Therefore, when the intake port 120 is connected to the battery case at a side opposite to a side at which the intake port 120 is connected to the body 110, the gas generated in the battery case may be introduced into the body 110 through the intake port 120.

The intake port 120 may include a member that absorbs heat to be contracted (hereinafter, referred to as a ‘heat shrink member’). In detail, the heat shrink member may be provided at a portion adjacent to a portion of the intake port 120, which is provided on the body 110. Thus, the gas heated inside the battery case may move through the intake port 120, and then, the intake port 120 may be contracted by heat to prevent external air of the vent sealing cap 1 from being introduced therein.

The exhaust port 130 is provided on the side surface of the body 110 and may be provided above the position at which the intake port 120 is provided. As described above, since the exhaust port 130 is provided on the side surface of the body 110, even if the opening/closing member 140 provided in the hollow of the body 110 ascends by the pressure of the intake port 120, the exhaust port 130 may not be closed but be opened to exhaust the air. In addition, since the exhaust port 130 is provided above the position at which the intake port 120 is provided, when the pressure of the intake port 120 increases, the opening/closing member 140 may ascend to form a structure to open the exhaust port 130.

Referring to FIG. 3, the exhaust port 130 may be provided on an axis different from an axis on which the intake port 120 is provided, based on the transverse cross-section of the body 110. As described above, when the axes of the intake port 120 and the exhaust port 130 are formed to be misaligned with each other, it is possible to minimize the reverse introduction of the gas after the gas is exhausted or discharged to the exhaust port 130 of the vent sealing cap 1. However, the intake port 120 and the exhaust port 130 are not necessarily limited to being provided on the different axes and thus may be placed on the same axis.

The exhaust port 130 may include an alarm generation device that generates a signal by sensing a flow of the gas. The alarm generation device includes various devices for generating a sound signal, a visual signal, and the like and may be a device commonly used in the art. For example, the sound signal may generate an alarm sound, and the visual signal may be a signal indicating that the ventilation is generated in the vent sealing cap 1 or a battery module connected thereto, a pack, or an instrument panel of a vehicle in which a battery is installed.

Next, the opening/closing member 140 will be described in detail with reference to FIGS. 1 and 2.

The opening/closing member 140 is provided in the hollow inside of the body 110 and may be, for example, a member made of a metal such as a weight having a sufficient weight. As described above, the opening/closing member 140 has a self-weight and may open or close the connection between the intake port 120 and the exhaust port 130 while moving through the inner hollow of the body 110 by the change in pressure of the intake port 120.

When the pressure of the intake port 120 is greater than a preset value, the opening/closing member 140 may open the connection between the intake port 120 and the exhaust port 130, and when the pressure of the intake port 120 is less than the preset value, the opening/closing member 140 may close the connection between the intake port 120 and the exhaust port 130.

Here, the preset value is a value obtained by adding a value, which is obtained by dividing the weight of the opening/closing member 140 by a unit area of the opening/closing member 140, to a value of a pressure applied to a volume of a space disposed in an upper portion of the hollow of the body 110 sealed by the opening/closing member 140 in a state in which the opening/closing member 140 ascends in the hollow within the body 110 so that a bottom surface of the opening/closing member 140 and a bottom surface of the exhaust port 130 coincide with each other.

The opening/closing member 140 of the vent sealing cap 1 for the secondary battery according to the present invention may include an elevation assistance groove 141 that is opened toward the gas inflow direction through the intake port 120 and has a shape recessed toward a central portion of the opening/closing member 140. As described above, when the elevation assistance groove 141 is formed in a center of the opening/closing member 140 as described above, an area that is subjected to upward force increases, and thus, the opening/closing member 140 may more easily ascend in the hollow within the body 110, and also, the opening/closing member 140 may ascend even with a small internal pressure or a change in pressure of the intake port 120 to cause the ventilation.

In particular, the elevation assistance groove 141 may be formed in a hairpin structure including an inlet, through which the gas is introduced, and a head having a spherical diameter larger than a width of the inlet, and a size of the area subjected to an upward pressure by the head may increase.

In addition, the opening/closing member 140 may have the spiral guide protrusion formed on the outer circumferential surface as described above, and the guide protrusion may be inserted into the guide groove of the body 110 so that the opening/closing member 140 is elevated while rotating. As described above, the opening/closing member 140 may be elevated by a pressure of the intake port 120 while improving sealing force of the opening/closing member 140 by the spiral guide groove formed in the inner circumferential surface of the body 110 and the spiral guide protrusion formed on the outer circumferential surface of the opening/closing member 140, and as necessary, the opening/closing member 140 may be utilized as a means to adjust the pressure for generating the ventilation.

The above-described vent sealing cap 1 for the secondary battery may be made of various materials. Specifically, the body 110, the intake port 120, the exhaust port 130, or the opening/closing member 140 of the vent sealing cap 1 for the secondary battery may be made of various materials.

Here, at least one of the body 110, the intake port 120, the exhaust port 130, or the opening/closing member 140 may undergo mechanical or chemical deformation even when a high-temperature gas is discharged from the inside of the secondary battery, and thus, it may be preferable that the at least one of the body 110, the intake port 120, the exhaust port 130, or the opening/closing member 140 is made of a high heat-resistant material so that physical properties are not significantly deteriorated.

In addition, at least one of the body 110, the intake port 120, the exhaust port 130, or the opening/closing member 140 may be ruptured to be deformed when the internal gas pressure is greater than or equal to a predetermined pressure, and thus, it may be preferable that the at least one of the body 110, the intake port 120, the exhaust port 130, or the opening/closing member 140 is made of a material that withstands a predetermined pressure. Here, the predetermined pressure may be various pressure values and may be, for example, 7 bar or more.

That is, the body 110, the intake port 120, the exhaust port 130, or the opening/closing member 140 may be made of any material as long as the material satisfies any one of the above-described conditions. For example, at least one of the body 110, the intake port 120, the exhaust port 130, or the opening/closing member 140 may include a high heat-resistant plastic type of poly phenylene sulfide (PPS) and poly imide (PI) or may include aluminum (Al) or stainless steel (SUS), which are metal materials.

### Embodiment 2

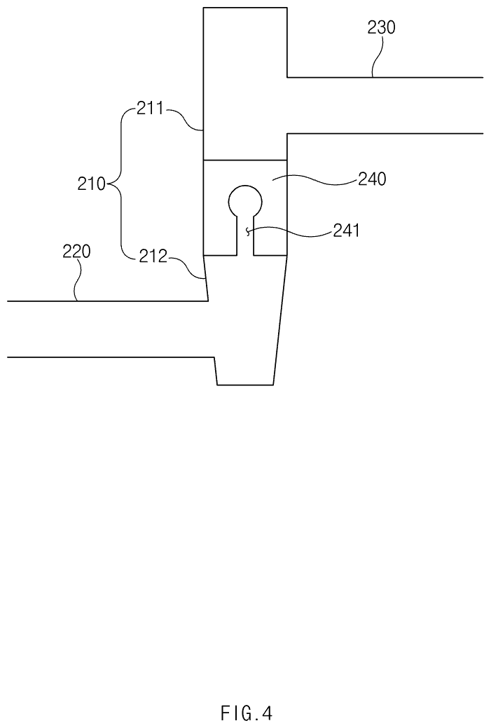

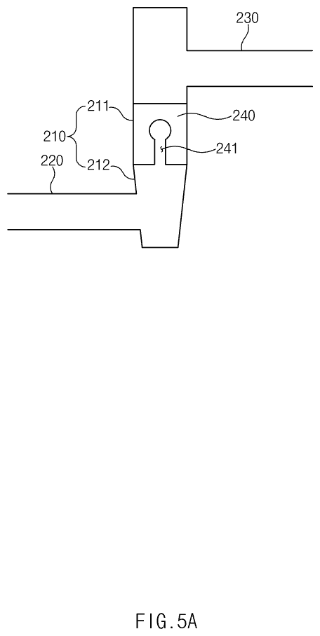

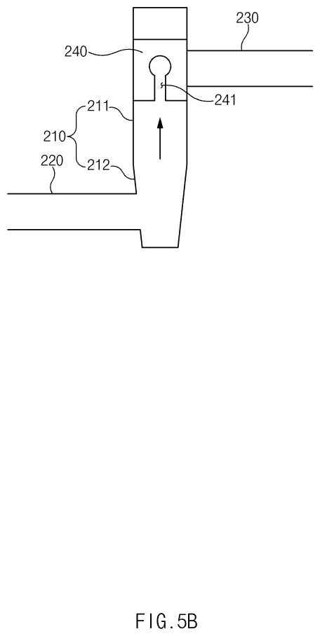

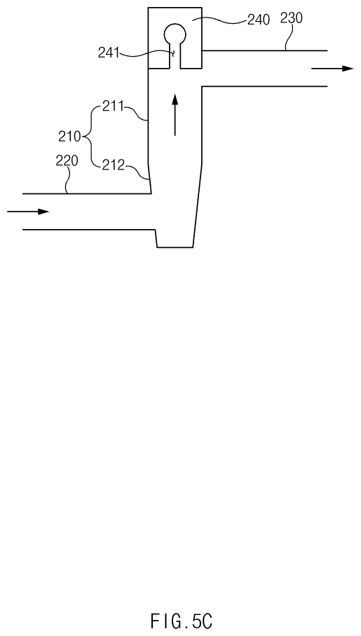

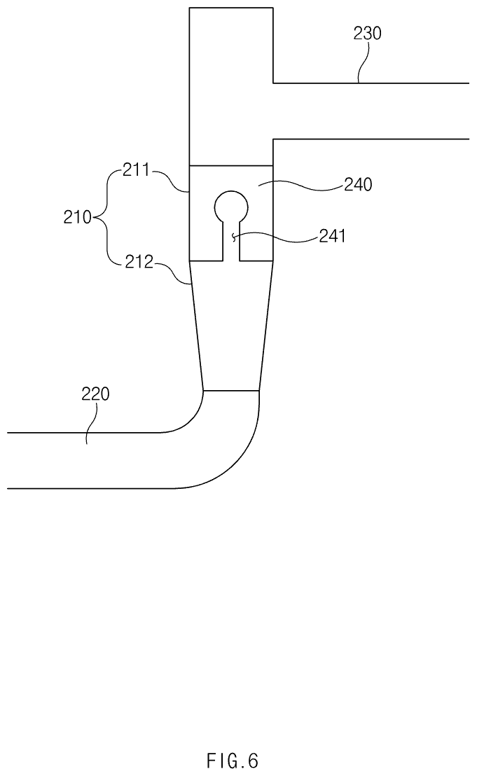

FIG. 4 is a side cross-sectional view of a vent sealing cap for a secondary battery according to Embodiment 2 of the present invention. FIGS. 5A-5C are views illustrating a process of performing ventilation in the vent sealing cap for the secondary battery according to Embodiment 2 of the present invention. FIG. 6 is a side cross-sectional view illustrating a state in which an intake port is formed on a bottom surface of a stopping part in the vent sealing cap for the secondary battery according to Embodiment 2 of the present invention.

Embodiment 2 of the present invention is different from Embodiment 1 in that a body 210 according to Embodiment 1 includes a movable part 211 and a stopping part 212.

The contents that are duplicated with Embodiment 1 will be omitted as much as possible, and Embodiment 2 will be described with a focus on the differences. That is, it is obvious that the contents that are not described in Embodiment 2 may be regarded as the contents of Embodiment 1 if necessary.

Referring to FIG. 4, a body 210 of a vent sealing cap for a secondary battery according to Embodiment 2 of the present invention includes a movable part 211 and a stopping part 212.

The movable part 211 is formed so that a cross-sectional area of a hollow of the body 210 is the same as a transverse cross-sectional area of the opening/closing member 240 so that the opening/closing member 240 moves in a sealed state. The stopping part 212 may be provided to be connected to a lower portion of the movable part 211 and has a hollow having a cross-sectional area less than the transverse cross-section of the opening/closing member 240 to prevent the opening/closing member 240 from moving downward by a self-weight thereof, thereby preventing the body 210 from being seated on a bottom surface of the body 210.

The stopping part 212 may be formed so that the cross-sectional area of the hollow is less than the transverse cross-section of the opening/closing member 240 and may be provided to have a height difference while forming a right angle with respect to the movable part 211 or may be provided in a shape, in which an area of an upper side connected to the movable part 211 is the same as the movable part 211, and an area gradually decreases downward.

In Embodiment 2 of the present invention, an exhaust port 230 may be formed on a side surface of the movable part 211, and an intake port 220 may be formed on a side surface of the stop part 212. Also, as illustrated in FIG. 6, the exhaust port 230 may be formed on the side surface of the movable part 211, and the intake port 220 may be formed on a bottom surface of the stopping part 212. As described above, when the intake port 220 is formed on the bottom surface of the stopping part 212, the opening/closing member 240 may more easily ascend when a gas is introduced from the intake port 220.

In the vent sealing cap for the secondary battery according to Embodiment 2 of the present invention, a process of generating ventilation by opening or closing connection between the intake port 220 and the exhaust port 230 may be opened or closed by the elevation of the opening/closing member 240 is illustrated in FIGS. 5A-C, and this process may be understood as being the same as the operation in Embodiment 1.

### Embodiment 3

FIG. 7 is a perspective view of a secondary battery according to Embodiment 3 of the present invention.

Embodiment 3 of the present invention is different from Embodiments 1 and 2 in that this embodiment relates to a secondary battery 2 including the vent sealing cap 1 for the secondary battery according to Embodiment 1 or 2.

The contents that are duplicated with Embodiments 1 and 2 will be omitted as much as possible, and Embodiment 3 will be described with a focus on the differences. That is, it is obvious that the contents that are not described in Embodiment 3 may be regarded as the contents of Embodiments 1 and 2 if necessary.

Referring to FIG. 7, a secondary battery 2 according to Embodiment 3 of the present invention includes an electrode assembly, a battery case, and a vent sealing cap.

The electrode assembly is formed by stacking a positive electrode, a separator, a negative electrode, and a separator. Here, the electrode assembly may be various types of electrode assemblies such as a jelly-roll type formed by winding a long sheet shape, a stack type, in which unit cells cut to a predetermined size are stacked, and a stack/folding type in which unit cells are stacked, and a separator is folded.

As for the battery case, it is sufficient if the electrode assembly is accommodated therein, and for example, any one of a can type and a pouch type including a cylindrical shape or a prismatic shape may be selected.

The vent sealing cap 1 may be provided in the battery case. For example, in the case of the pouch type, the vent sealing cap 1 may be provided at a sealing portion to perform a vent function. A body 310 of the vent sealing cap has a hollow formed therein, and an intake port 320 and an exhaust port 330 are provided on the body 310. Here, the exhaust port 330 is disposed above a position, at which the intake port 320 is provided, on the body 310. The intake port 320 is connected to the inside of the battery case so that air is introduced into the body 310 from the battery case, and the air introduced into the intake port 320 is discharged through the exhaust port 330 via the body 310.

The opening/closing member 340 is provided in the hollow inside of the body 310 to open or close connection between the intake port 320 and the exhaust port 330 while moving inside the hollow by a change in pressure of the intake port 320. Here, the opening of the connection between the intake port 320 and the exhaust port 330 may mean that the opening/closing member 340 moves above the body 310 to open a flow of air between the intake port 320 and the exhaust port 330 so that a gas within the battery case is introduced into the vent sealing cap through the intake port 320 and discharged through the exhaust port 330 to cause ventilation, and the closing of the connection between the intake port 320 and the exhaust port 330 may mean that the opening/closing member 340 is provided between the intake port 320 and the exhaust port 330 in the hollow within the body 310 to block the flow of the air between the intake port 320 and the exhaust port 330.

As described above, the secondary battery according to Embodiment 3 of the present invention may include the vent sealing cap, and when the gas is generated in the battery case to increase in internal pressure, the gas generated in the battery case may be discharged to the outside of the battery case, and when the pressure decreases due to the discharge of the gas, the vent sealing cap may be closed to prevent the air from being reversely introduced, thereby preventing the secondary battery from being ignited or exploded due to reaction of oxygen inside the battery case and improving safety of the secondary battery.

The body 310, the intake port 320, and the exhaust port 330, which are other components according to Embodiment 3 of the present invention, may be understood as the same as those described in Embodiments 1 and 2.

The opening/closing member may include an elevation assistance groove that is opened toward a gas inflow direction through the intake port and has a shape recessed toward a central portion of the opening/closing member. In addition, the elevation assistance groove may be formed in a hairpin structure including an inlet, through which the gas is introduced, and a head having a spherical shape having a diameter greater than a width of the inlet.

While the embodiments of the present invention have been described with reference to the specific embodiments, it will be apparent to those skilled in the art that various changes and modifications may be made without departing from the spirit and scope of the invention as defined in the following claims.

### DESCRIPTION OF THE SYMBOLS

1: Vent sealing cap for secondary battery
110: Body
120: Intake port
130: Exhaust port
140: Opening/closing member
141: Elevation assistance groove
210: Body
211: Movable part
212: Stopping part
220: Intake port
230: Exhaust port
240: Opening/closing member
310: Body
320: Intake port
330: Exhaust port
340: Opening/closing member
2: Secondary battery

1. A vent sealing cap for a secondary battery, comprising:
a body defining an inner hollow space;
an intake port provided on the provided at a first location on the body;
an exhaust port second location on the body, the second location being different from the first location; and
an opening/closing member disposed within the hollow space to open or close a fluid communication between the intake port and the exhaust port in response to a change in pressure of the intake port.

2. The vent sealing cap of claim 1, wherein the intake port is provided on a side surface of the body.

3. The vent sealing cap of claim 2, wherein the exhaust port is provided on the side surface of the body,
the exhaust port extending along a first axis and the intake port extending along a second axis, the first axis being different from the second axis.

4. The vent sealing cap of claim 1, wherein the opening/closing member opens the fluid communication between the intake port and the exhaust port when a pressure of the intake port is greater than a preset value, and
the opening/closing member closes the fluid communication between the intake port and the exhaust port when the pressure of the intake port is less than the preset value.

5. The vent sealing cap of claim 1, wherein the opening/closing member comprises an elevation assistance groove that is opened in a direction in which a gas is introduced through the intake port, the elevation assistance groove having a recessed shape toward a central portion of the opening/closing member.

6. The vent sealing cap of claim 5, wherein the elevation assistance groove is provided in a hairpin structure comprising an inlet, through which the gas is introduced, and a head having a spherical shape with a diameter greater than a width of the inlet.

7. The vent sealing cap of claim 1, wherein the body has a transverse cross-section defining a circular shape.

8. The vent sealing cap of claim 7, wherein a spiral guide groove is formed in an inner circumferential surface of the body.

9. The vent sealing cap of claim 8, wherein a spiral guide protrusion is formed on an outer circumferential surface of the opening/closing member,
the guide protrusion being inserted into the guide groove of the body so as to be elevated.

10. The vent sealing cap of claim 1, wherein the intake port comprises a member contracts due to heat absorption.

11. The vent sealing cap of claim 1, wherein the exhaust port comprises an alarm generation device configured to generate a signal by sensing a flow of a gas.

12. The vent sealing cap of claim 1, wherein the body comprises:
a movable part having a cross-sectional area of the hollow space, which is the same as a transverse cross-sectional area of the opening/closing member such that the opening/closing member is movable when the hollow space is sealed; and
a stopping part provided below the movable part and having a cross-sectional area of the hollow space, which is less than the transverse cross-sectional area of the opening/closing member such that a movement of the opening/closing member is stopped.

13. The vent sealing cap of claim 12, wherein the exhaust port is formed on a side surface of the movable part, and
the intake port is formed on a side surface of the stopping part.

14. The vent sealing cap of claim 12, wherein the intake port is formed on a side surface of the movable part, and
the intake port is formed on a bottom surface of the stopping part.

15. The vent sealing cap of claim 1, wherein at least one of the body, the intake port, the exhaust port, or the opening/closing member is made of at least one of poly phenylene sulfide (PPS), poly imide (PI), aluminum (Al), or stainless steel (SUS).

16. A secondary battery comprising:
an electrode assembly in which a positive electrode, a separator, a negative electrode, and a separator are stacked;
a battery case in which the electrode assembly is accommodated; and
a vent sealing cap provided in the battery case,
wherein the vent sealing cap comprises:
a body defining an inner hollow space;
an intake port provided at a first location on the body;
an exhaust port provided at a second location on the body, the first location being different from the second location; and
an opening/closing member within the hollow space to open or close a fluid communication between the intake port and the exhaust port in response to a pressure difference of the intake port.

17. The secondary battery of claim 16, wherein the opening/closing member comprises an elevation assistance groove that is opened in a direction, in which a gas is introduced through the intake port, the elevation assistance groove having a recessed shape toward a central portion of the opening/closing member.

18. The secondary battery of claim 17, wherein the elevation assistance groove is provided in a hairpin structure comprising an inlet, through which the gas is introduced, and a head having a spherical shape defining a diameter greater than a width of the inlet.

19. The secondary battery of claim 16, wherein at least one of the body, the intake port, the exhaust port, or the opening/closing member is made of at least one of poly phenylene sulfide (PPS), poly imide (PI), aluminum (Al), or stainless steel (SUS).
